(19) United States
(12) Patent Application Publication
(10) Pub. No.: US 2021/0122125 A1
(43) Pub. Date: Apr. 29, 2021

(54) POLYMER COMPOSITES AND METHODS OF MAKING

(71) Applicant: 3M INNOVATIVE PROPERTIES COMPANY, St. Paul, MN (US)

(72) Inventors: Erin A. McDowell, Afton, MN (US); Jo A. Etter, Kirkland, WA (US); Kristy A. Jost, Woodbury, MN (US); Andrew J. Ouderkirk, Kirkland, WA (US); Robert R. Kieschke, Woodbury, MN (US); Rachel Andreasen, St. Paul, MN (US)

(21) Appl. No.: 16/603,482

(22) PCT Filed: May 18, 2018
(86) PCT No.: PCT/IB2018/053530

§ 371 Date: Oct. 7, 2019

Related U.S. Application Data
(60) Provisional application No. 62/513,517, filed on Jun. 1, 2017.

(51) Int. Cl. B29C 70/16; B29C 35/02

(52) U.S. Cl. CPC B29C 70/16; B29C 35/0222; B29C 2035/0827; B29C 35/0288; B29C 35/0266

(57) ABSTRACT

Polymer composites and methods of making wherein the polymer composites include a continuous matrix phase and a reinforcing phase, with varying properties (material and/or physical).

### BACKGROUND

Many plants and animals have an overall shape and support system that is built on complex shapes that are determined at least in part by composites with complex shapes. Biological systems have developed these complex shapes primarily due to the efficiency and mechanical advantages offered by a complex shape compared to a less hierarchical structure. Most human-built structures are made from relatively simple shapes, such as rods, tubes, and other, primarily, extended two-dimensional materials. Human-built systems use these extended two-dimensional structures because this simplifies and reduces the cost compared to complex structures. Composite structures are a good example of using simple structures to reduce cost. Composites commonly use a thermally cured resin, such as epoxy, as a matrix phase. The thermally cured resins can have a long cure time, ranging from many minutes to over an hour. Cure time is a particular issue when using pre-impregnated composites, since the resin must not cure over the product's shelf-life, where the shelf-life may be 6 months or more.

The most common approach to curing the resin in a composite shape is to form a relatively large section of the composite to the desired shape, then cure the whole shape at once using, e.g., thermal energy or actinic radiation for curing. Another common approach is to produce the desired shape through a continuous process, such as pultrusion or winding, and curing the resin impregnating the composite. These processes develop simple shapes that are commonly collinear (i.e., lying in the same straight line), or have an extended two-dimensional shape. A common aspect of both the molded and continuous processes is that they produce structures with physical and chemical properties that are the same throughout their structures. Methods are needed that can provide polymer composites that have complex structures, particularly with respect to differing physical properties and/or differing material properties

### SUMMARY

The present disclosure provides polymer composites and methods of making. Such polymer composites include a continuous matrix phase and a reinforcing phase.

In one embodiment, a polymer composite is provided that includes: a continuous matrix phase including contiguous first and second polymeric regions, wherein: the first polymeric region has a first modulus or a first Tg; the second polymeric region has a second modulus or a second Tg; and the second modulus is different than the first modulus and/or the second Tg is different than the first Tg; and a reinforcing phase.

In another embodiment, a polymer composite is provided that includes: a continuous matrix phase including contiguous first and second polymeric regions, wherein the contiguous first and second polymeric regions have different material properties (e.g., modulus, Tg, internal stress, polydispersity); and a reinforcing phase; wherein the polymer composite includes contiguous first and second composite regions, each having different physical properties (e.g., polymer content, bending strength, stiffness).

In yet another embodiment, a method for producing a fully cured polymer composite is provided, the method includes: providing a polymer resin and a reinforcing material dispersed therein; curing the polymer resin in a first polymeric region at a first rate, and curing the polymer resin in a second polymeric region at a second rate, to form the fully cured polymer composite; wherein the first and second cure rates are different; and wherein the first polymeric region is contiguous with the second polymeric region in the fully cured polymer composite.

A “polymer composite” is a material made from two or more constituent materials with significantly different physical or chemical properties that, when combined, produce a material with characteristics different from the individual components. The individual components remain separate and distinct within the finished structure. The polymer composite is not a layered system in and of itself (although the composite could be used in a layered construction). In certain embodiments, a polymer composite does not include an interpenetrating network of the polymer.

The terms “polymer,” “polymer resin,” “polymeric material,” and “polymeric region” include, but are not limited to, organic homopolymers, copolymers, such as for example, block, graft, random, and copolymers, terpolymers, etc., and blends and modifications thereof. Furthermore, unless otherwise specifically limited, the term “polymer” shall include all possible geometrical configurations of the material. These configurations include, but are not limited to, isotactic, syndiotactic, and atactic symmetries.

Herein, the term “comprises” and variations thereof do not have a limiting meaning where these terms appear in the description and claims. Such terms will be understood to imply the inclusion of a stated step or element or group of steps or elements but not the exclusion of any other step or element or group of steps or elements. By “consisting of” is meant including, and limited to, whatever follows the phrase “consisting of.” Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they materially affect the activity or action of the listed elements.

The words “preferred” and “preferably” refer to embodiments of the disclosure that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise.

The term “and/or” means one or all of the listed elements or a combination of any two or more of the listed elements.

Also herein, all numbers are assumed to be modified by the term “about” and in certain embodiments, preferably, by the term “exactly.” As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

As used herein, the term “room temperature” refers to a temperature of 20° C. to 25° C., or in certain embodiments, 22° C. to 25° C.

The term “in the range” or “within a range” (and similar statements) includes the endpoints of the stated range.

Groupings of alternative elements or embodiments disclosed herein are not to be construed as limitations. Each group member may be referred to and claimed individually or in any combination with other members of the group or other elements found therein. It is anticipated that one or more members of a group may be included in, or deleted from, a group for reasons of convenience and/or patentability. When any such inclusion or deletion occurs, the specification is herein deemed to contain the group as modified thus fulfilling the written description of all Markush groups used in the appended claims.

Reference throughout this specification to “one embodiment,” “an embodiment,” “certain embodiments,” or “some embodiments,” etc., means that a particular feature, configuration, composition, or characteristic described in connection with the embodiment is included in at least one embodiment of the invention. Thus, the appearances of such phrases in various places throughout this specification are not necessarily referring to the same embodiment of the invention. Furthermore, the particular features, configurations, compositions, or characteristics may be combined in any suitable manner in one or more embodiments.

The above summary of the present disclosure is not intended to describe each disclosed embodiment or every implementation of the present invention. The description that follows more particularly exemplifies illustrative embodiments. In several places throughout the application, guidance is provided through lists of examples, which examples may be used in various combinations. In each instance, the recited list serves only as a representative group and should not be interpreted as an exclusive list.

### BRIEF DESCRIPTION OF THE DRAWINGS

FIG. 1 is a schematic of an apparatus for curing a polymer composite fiber of the present disclosure.

FIG. 2 is a graph of temperature of a polymer composite fiber over time during curing as described in Example 1.

FIG. 3 is a graph of the force vs. displacement of a cured polymer composite fiber of the present disclosure prepared according to Example 1.

FIG. 4 is a graph of calculated stress and strain of the cured polymer composite fiber prepared according to Example 2.

FIG. 5 is a graph of temperature of a polymer composite fiber over time during curing as described in Example 2.

FIG. 6 is a graph of the force vs. displacement of a cured polymer composite fiber of the present disclosure prepared according to Example 2.

FIG. 7 is a graph of calculated stress and strain of the cured polymer composite fiber prepared according to Example 2.

FIG. 8 is a graph of temperature of a polymer composite fiber over time during curing as described in Example 3.

FIG. 9 is a graph of the force vs. displacement of a cured polymer composite fiber of the present disclosure prepared according to Example 3.

FIG. 10 is a graph of calculated stress and strain of the cured polymer composite fiber prepared according to Example 3.

FIG. 11 is a graph of temperature of a polymer composite fiber over time during curing as described in Example 4.

FIG. 12 is a graph of the force vs. displacement of a cured polymer composite fiber of the present disclosure prepared according to Example 4.

FIG. 13 is a graph of calculated stress and strain of the cured polymer composite fiber prepared according to Example 4.

FIG. 14 is a schematic of a polymer composite of an embodiment of the present disclosure in the form of a knitted structure.

FIG. 15 is a schematic of a polymer composite of an embodiment of the present disclosure in the form of a looped structure.

FIG. 16 is a schematic of a polymer composite of an embodiment of the present disclosure in the form of a looped structure.

FIG. 17 is a schematic of a polymer composite prepared according to Example 8.

FIG. 18 is a schematic of a 3D-articulated system for preparing polymer composite fibers of the present disclosure.

FIG. 19 is a perspective view of a fiber delivery head for preparing polymer composite fibers of the present disclosure.

FIG. 20 is a cross-sectional view of a resin impregnation head for preparing polymer composite fibers of the present disclosure.

### DETAILED DESCRIPTION OF ILLUSTRATIVE EMBODIMENTS

The present disclosure provides polymer composites and methods of making. Such polymer composites include a continuous polymeric matrix phase and a reinforcing phase dispersed therein. The polymer composites can be in a variety of shapes. The polymer composites can have complex structures, particularly with respect to differing physical properties and/or differing material properties in contiguous regions (i.e., adjacent or touching regions) within a structure.

The composite can be in the form of fibers (i.e., filaments) or rods, for example, which may be continuous. Such fibers or rods may have differing properties (e.g., flexibility/rigidity) in contiguous regions along their length. In certain embodiments, the polymer composite is in the form of continuous fibers or rods. Such composite fibers or rods may be in the form a tow (i.e., a bundle of continuous reinforcing fibers) wherein the space between the reinforcing fibers is at least partially filled with a polymeric matrix phase.

In certain embodiments, continuous composite fibers may be formed into a woven or knitted fabric. Various regions of the woven or knitted fibers can be cured to have a flexural modulus of at least 10 GPa, and adjacent regions connected by at least one common fiber where the modulus is less than 1 GPa.

In certain embodiments, the polymer composite is in the form of a film. Such film may have differing properties in contiguous regions along the length and/or width of the film.

Typically, the polymer composites are at least partially cured. In certain embodiments, the polymer composites are fully cured, such that no further curing can occur. Alternatively, the polymer composites can be partially cured for various applications. If desired, a polymer composite can have contiguous regions that possess different levels of cure. For example, a polymer composite can have contiguous regions that are fully cured and partially cured.

Curing, in this context, refers to applying processes to increase the molecular weight, or crosslink density, or both. That is, curing can involve polymerizing, crosslinking, or both. Functionally, the degree of cure is measured through a stress-strain curve measured at low displacement rates. The peak stress (s1) for the uncured resin is measured, two partially cured composites are prepared, and the peak stress (s2) for one of the partially cured composites is measured. The second partially cured composite is then fully cured, using the cure conditions recommended by the manufacturer of the resin, and the peak stress (s3) of the fully cured composite is measured. The degree of partial curing is defined by the equation (s2−s1)/(s3−s1). The degree of curing of the composited may be at least 10%, at least 20%, at least 50%, at least 75%, or at least 90%, depending on the application.

In certain embodiments, the continuous matrix phase includes contiguous first and second polymeric regions, wherein: the first polymeric region has a first modulus or a first Tg; the second polymeric region has a second modulus or a second Tg; and the second modulus is different than the first modulus and/or the second Tg is different than the first Tg. For example, in certain embodiments, the ratio of the first modulus to the second modulus is greater than 1.2.

In certain embodiments, the continuous matrix phase includes contiguous first and second polymeric regions, wherein the contiguous first and second polymeric regions have different material properties (e.g., modulus, Tg); and contiguous first and second composite regions, each having different physical properties (e.g., polymer content, bending strength, stiffness).

In certain embodiments, the first and second composite regions each have a polymer content, wherein the polymer content of the first composite region is different than the polymer content of the second composite region. In this context, polymer content (i.e., resin loading) refers to the weight fraction of the curable polymer resin to the total weight of the reinforcing material (e.g., reinforcing fibers) and resin. For example, the polymer content (i.e., resin loading) of the first composite region is at least 5%, or at least 10%, or at least 15%, or at least 20%, less than the polymer content of the second composite region.

If the composite is in the form of a fiber or rod and includes a continuous tow of reinforcing fibers, for example, and the fiber or rod has a cross-sectional area, such area may be different in the first and second composite regions. For example, the cross-sectional area of the first composite region is at least 5%, or at least 10%, or at least 15%, or at least 20%, greater than the cross-sectional area of the second composite region.

In this context, “cross-sectional area” is measured in a plane perpendicular to the length direction of the tow. In the case of a curved tow, the length direction is the tangent to the curve. The area is measured in the midpoint of the region, or the area may be measured at along the length of the tow. Area is preferably measured through microscopic imaging measurements made of cross-sections made of the tow.

In certain embodiments, heating the material rapidly may cause an increase in cross-sectional area, even though the resin is becoming denser on curing. Increased cross-sectional area may be due to pores being formed due to outgassing of the resin, or vaporization of one or more components in the curable resin, or both. Porosity may be further increased by adding components to the resin to increase vapor pressure. Surprisingly, increased porosity may be desirable since it allows control of different combinations of stiffness and strength for the same material.

To better understand the use of the phrase “composite region” the following example is provided. The composite region of a fiber or rod refers to a length of the composite, where length is measured along the orientation direction of the reinforcing fibers making up the composite. The region may be straight, or may be curved by applying predetermined displacement of the reinforcing fibers at the two ends of the region making up the length, or by applying forces to one or more positions along the length of the reinforcing fibers to form, for example, an arc or other complex shape.

In certain embodiments, the first and second composite regions each have a bending strength, wherein the bending strength of the first composite region is different than the bending strength of the second composite region. For example, the bending strength of the first composite region is at least 5%, or at least 10%, or at least 15%, or at least 20%, higher than the bending strength of the second composite region.

In certain embodiments, the first and second composite regions each have a stiffness, wherein the stiffness of the first composite region is different than the stiffness of the second composite region. For example, the stiffness of the first composite region is at least 10%, or at least 20%, or at least 50%, or at least 100%, higher than the stiffness of the second composite region.

The different material properties (e.g., modulus, Tg, internal stress, polydispersity) of the first and second contiguous polymeric regions and/or the different physical properties (e.g., polymer content, bending strength, stiffness) of the first and second contiguous composite regions may result from changing the chemistry (e.g., modulus) of the matrix. Alternatively, they may result from changing the curing mechanism, curing conditions, and/or extent of cure for the matrix.

In certain embodiments, the first and second polymeric regions include the same polymer composition. In certain embodiments, the first and second polymeric regions include the same polymer composition cured differently. For example, the two regions are along the length of a fiber or rod, changing modulus along the length of the fiber or rod as a result of being cured differently (e.g., cured for different periods of time).

In certain embodiments, the first and second polymeric regions include different amounts of the same polymer composition. For example, the polymer composition can include two different amounts of the same polymer resins (e.g., epoxies) that could provide different local moduli.

In certain embodiments, the first and second polymeric regions include different polymer compositions (e.g., two epoxies with two different Tg's, or an epoxy and a polyolefin).

In certain embodiments, the continuous matrix phase includes a thermally cured resin. In certain embodiments, the thermally cured resin includes an epoxy resin, a polyester resin, a vinyl ester resin, a cyanate ester resin, or combinations thereof (e.g., blends or copolymers thereof). In certain embodiments, the thermally cured resin includes an epoxy resin.

In certain embodiments, the continuous matrix phase includes a radiation cured resin (i.e., a resin cured upon exposure to actinic radiation), particularly curable by UV radiation. In certain embodiments, the radiation cured resin includes radiation sensitive curatives or radical generators, such as photoinitiators. Examples of commercially available resins capable of being cured using actinic radiation include ethylenically unsaturated resins, particularly those including acrylate or methacrylate groups.

In certain embodiments, the continuous matrix phase includes a dual cured resin (i.e., a resin that uses both thermal energy and actinic radiation to activate polymerization). In certain embodiments, the dual cured resin includes both functional groups that polymerize or crosslink upon exposure to thermal energy and functional groups that polymerize or crosslink upon exposure to actinic radiation (e.g., UV radiation).

Examples of suitable resins are described in U.S. Pat. No. 9,366,790 (Spurgeon et al.), U.S. Pat. No. 9,329,311 (Halverson et al.), U.S. Pat. No. 9,523,919 (Benson Jr., et al.).

Polymer composites of the present disclosure include a reinforcing phase dispersed within the continuous polymeric matrix phase. In certain embodiments, the reinforcing phase is uniformly dispersed within the continuous polymeric matrix phase.

In certain embodiments, the reinforcing phase includes an organic material, an inorganic material, or a combination (e.g., mixture) thereof. In certain embodiments, the reinforcing phase includes carbon (e.g., carbon nanotubes such as that available under the name Fullerene, multi-walled carbon nanotube, from Alfa Aesar), polyaramide (e.g., that available under the tradename KEVLAR from DuPont), polyolefin (e.g., polyethylene such as highly oriented ultrahigh molecular weight polyethylene, such as that available under the tradename SPECTRA fibers from Honeywell), glass, and metal.

In certain embodiments, the reinforcing phase is in the form of fibers. The reinforcing fibers may be electrically conductive fibers. The reinforcing fibers may be transparent to actinic radiation. The reinforcing fibers may be continuous. The reinforcing fibers may be discontinuous (e.g., staple fibers). For example, with polymer composites in the form of fibers to rods, depending on the angle of view, bundles of reinforcing fibers can be continuous (along the length of the composite fibers or rods) or discontinuous (along the cross-section of the fibers or rods).

Fully cured polymer composites of the present disclosure can be made using a variety of methods. One method involves varying the curing rate. For example, such a method includes: providing a polymer resin and a reinforcing material dispersed therein; curing the polymer resin in a first polymeric region at a first rate, and curing the polymer resin in a second polymeric region at a second rate, to form the fully cured polymer composite; wherein the first and second cure rates are different; and wherein the first polymeric region is contiguous with the second polymeric region in the fully cured polymer composite.

Herein, “curing” refers to polymerizing and optionally crosslinking the resin. Such curing can occur by thermally curing a polymer resin such as an epoxy resin, a polyester resin, a vinyl ester resin, a cyanate ester resin, or combinations thereof. If the reinforcing material is electrically conductive, such as continuous electrically conductive fibers, curing can occur by heating the polymer resin through electrical resistance of the conductive fibers.

Curing can occur by exposing the resin to actinic radiation and optionally, for a dual cured resin, exposing the resin to both thermal energy and actinic radiation.

Curing can use a wide variety of conditions (e.g., temperatures and times) depending on the resins used. Desirably, curing occurs in a relatively short period of time. For example, curing can occur in less than 10 minutes, less than 5 minutes, less than 1 minute, less than 30 seconds, or less than 15 seconds. Desirably, conditions are selected to provide rapid and significant cure before the resin decomposes.

Temperatures can be varied such that during the manufacture of a composite, various regions can be subjected to localized heating relative to adjacent regions. For example, the temperatures to which adjacent regions are exposed can be at least 50° C., at least 75° C., at least 100° C., or at least 150° C. different. Such temperature differences can be held for up to 10 minutes, up to 5 minutes, up to 2 minutes, up to 1 minute, or up to 30 seconds.

Curing can occur continuously or intermittently. For example, if a polymer composite in the form of a continuous fiber or rod is being formed, the method is a continuous process that involves curing continuously along the length of the fiber or rod.

A more specific method of making a polymer composite in the form of a continuous composite fiber or rod can involve the following: providing a continuous resin-impregnated tow comprising a polymeric resin and continuous reinforcing fibers dispersed therein; forming a first region of the continuous resin-impregnated tow into a first pre-determined shape; at least partially curing the resin in the first region; forming a second region of the continuous resin-impregnated tow into a second pre-determined shape; and at least partially curing the resin in the second region. The extent of cure in each of the first and second regions can be the same or different. The pre-determined shapes of the first and second regions can be the same or different.

The application of the curing energy (e.g., thermal energy and/or actinic radiation), the conditions of cure (e.g., time and temperature), and the extent of cure can be monitored using conventional equipment and techniques known to those skilled in the art. Monitoring can involve measuring one of more attributes of the region being cured. For example, this can include measuring temperature by a contact thermometer, a point IR pyrometer, an imaging pyrometer, or vapors or smoke emitted.

In certain embodiments, a composite structure could be engineered with stiff and soft segments, allowing for folding of, or within, the soft segments. That is, the stiffer segments maintain their shape whereas the softer segments are capable of changing shape and being folded. In this context, “folding” is where two relatively stiff, at least partially cured regions are connected by a third region between the first two regions, where the third region has a lower degree of cure (including no curing) rendering it softer, than the first two regions. The ability to create folded structures allows for rapid curing to thermally isolate that which is being cured from that which is not. For example, folding allows for localized heating of adjacent regions such that the temperatures to which adjacent regions are exposed can be at least 50° C., at least 75° C., at least 100° C., or at least 150° C. different.

The ability to create a material with segments of varying levels of cure and/or stiffnesses can create a gradient of properties. This allows for the formation of more complex shapes and structures.

In certain embodiments, lightweight open structures, such as trusses and spokes, can be formed from the methods and polymer composites of the present disclosure. Such systems would benefit from the ability to tailor the modulus of the composite material, at least because the attachment mechanism, or shear structure in the case of a truss, involves tight bend radii. A completely stiff system would not accommodate the required bend radii.

The methods and polymer composites of the present disclosure could be used in systems with controlled collapse, for maximum energy absorption. In order for composites to absorb energy, compressive collapse is required. Predetermining points of buckling down the length of a structure would drive progressive collapse. These systems could be designed for predetermined deformation by defining buckling zones which would be particularly useful in safety critical applications such as automotive applications.

The methods and polymer composites of the present disclosure can be used to create articles with complex shapes that would normally be formed by filament winding. Such articles could be formed by winding pre-cured prepreg, where the prepreg was cured to a state that allowed for easy bending around tight bend radii in the final part.

The methods and polymer composites of the present disclosure can be used to create layered 3-dimensional structures that are composed of a continuous material with different mechanical properties. For example, a synthetic heart valve could be created that is composed of a continuous material in the form of a (circular) valve with regions cured at different cure rates. The softest region at the center of the valve could be at the opening of the valve, with the stiffer regions toward the outer edges of the valve at the suture ring, which holds the device in place. Typically it is the mechanical moving parts which fail first in a heart valve. Making a single continuous device could reduce the chances for failure at the joints.

The methods and polymer composites of the present disclosure can be used to create articles having failure designed into the structure. This is due to the ability to create sections of a composite material with different mechanical properties between the sections. For example, a bottle cap could be designed that has a softer section that allows the consumer to open the cap. Such cap can be made in one step and composed of the same material. Extensions of this concept can be used in aerospace applications, automotive applications, and personal safety and consumer products.

### Illustrative Embodiments

Embodiment 1 is a polymer composite comprising: a continuous matrix phase comprising contiguous first and second polymeric regions, wherein: the first polymeric region has a first modulus or a first Tg; the second polymeric region has a second modulus or a second Tg; and the second modulus is different than the first modulus and/or the second Tg is different than the first Tg; and a reinforcing phase.

Embodiment 2 is the polymer composite of embodiment 1 wherein the first polymeric region and the second polymeric region comprise the same polymer composition.

Embodiment 3 is the polymer composite of embodiment 2 wherein the first and second polymeric regions comprise the same polymer composition (e.g., epoxies) cured differently (e.g., the two regions are along the length of a fiber or rod, thereby changing modulus along the length of the fiber or rod).

Embodiment 4 is the polymer composite of embodiment 1 wherein the first polymeric region and the second polymeric region comprise different polymer compositions (e.g., two epoxies with two different Tg's).

Embodiment 5 is the polymer composite of embodiment 1 wherein the first polymeric region and the second polymeric region comprise different amounts of the same polymer composition (e.g., two different amounts of the same epoxies that could have different local moduli).

Embodiment 6 is the polymer composite of any one of the preceding embodiments wherein the ratio of the first modulus to the second modulus is greater than 1.2.

Embodiment 7 is the polymer composite of any one of the preceding embodiments wherein the reinforcing phase comprises an organic material, an inorganic material, or a combination (e.g., mixture) thereof.

Embodiment 8 is the polymer composite of embodiment 7 wherein the reinforcing phase comprises carbon (e.g., carbon nanotubes), polyaramide, polyolefin (e.g., polyethylene such as highly oriented ultrahigh molecular weight polyethylene, glass, and metal.

Embodiment 9 is the polymer composite of any one of the preceding embodiments wherein the reinforcing phase is in the form of fibers.

Embodiment 10 is the polymer composite of embodiment 9 wherein the fibers are electrically conductive fibers.

Embodiment 11 is the polymer composite of any one of embodiments 1 to 10 wherein the reinforcing phase is continuous.

Embodiment 12 is the polymer composite of any one of embodiments 1 to 10 wherein the reinforcing phase is discontinuous.

Embodiment 13 is the polymer composite of any one of embodiments 1 to 12 wherein the continuous matrix phase comprises a thermally cured resin.

Embodiment 14 is the polymer composite of embodiment 13 wherein the thermally cured resin comprises an epoxy resin, a polyester resin, a vinyl ester resin, a cyanate ester resin, or combinations thereof (preferably, an epoxy resin).

Embodiment 15 is the polymer composite of any one of embodiments 1 to 12 wherein the continuous matrix phase comprises a radiation cured resin.

Embodiment 16 is the polymer composite of embodiment 15 wherein the radiation cured resin comprises a cured acrylate and/or methacrylate resin.

Embodiment 17 is the polymer composite of embodiment 15 or 16 wherein the radiation cured resin comprises radiation sensitive curatives or radical generators.

Embodiment 18 is the polymer composite of any one of embodiments 1 to 12 wherein the continuous matrix phase comprises a dual cured resin.

Embodiment 19 is the polymer composite of any one of embodiments 1 to 18 which is in the form of a film (having differing properties along the length and/or width of the film).

Embodiment 20 is the polymer composite of any one of embodiments 1 to 18 which is in the form of a fiber.

Embodiment 21 is the polymer composite of embodiment 20 wherein the fiber is a continuous fiber.

Embodiment 22 is the polymer composite of embodiment 21 wherein the continuous fiber has differing properties (e.g., flexibility/rigidity) along the length of the fiber.

Embodiment 23 is the polymer composite of any one of embodiments 20 to 22 wherein the fibers are in the form of a woven or knitted fabric.

Embodiment 24 is the polymer composite of any one of embodiments 1 to 18 which is in the form of a rod.

Embodiment 25 is a polymer composite comprising: a continuous matrix phase comprising contiguous first and second polymeric regions, wherein the contiguous first and second polymeric regions have different material properties (e.g., modulus, Tg); and a reinforcing phase; wherein the polymer composite comprises contiguous first and second composite regions, each having different physical properties (e.g., polymer content, bending strength, stiffness).

Embodiment 26 is the polymer composite of embodiment 25 wherein the first and second composite regions each have a polymer content, wherein the polymer content of the first composite region is different than the polymer content of the second composite region.

Embodiment 27 is the polymer composite of embodiment 26 wherein the polymer content of the first composite region is at least 5%, or at least 10%, or at least 15%, or at least 20%, less than the polymer content of the second composite region.

Embodiment 28 is the polymer composite of any one of embodiments 25 to 27 wherein the first and second composite regions each have a bending strength, wherein the bending strength of the first composite region is different than the bending strength of the second composite region.

Embodiment 29 is the polymer composite of embodiment 28 wherein the bending strength of the first composite region is at least 5%, or at least 10%, or at least 15%, or at least 20%, higher than the bending strength of the second composite region.

Embodiment 30 is the polymer composite of any one of embodiments 25 to 29 wherein the first and second composite regions each have a stiffness, wherein the stiffness of the first composite region is different than the stiffness of the second composite region.

Embodiment 31 is the polymer composite of embodiment 30 wherein the stiffness of the first composite region is at least 5%, or at least 10%, or at least 15%, or at least 20%, higher than the stiffness of the second composite region.

Embodiment 32 is the polymer composite of any one of embodiments 25 to 31 wherein the first polymeric region and the second polymeric region comprise the same polymer composition.

Embodiment 33 is the polymer composite of embodiment 32 wherein the first and second polymeric regions comprise the same polymer composition cured differently.

Embodiment 34 is the polymer composite of any one of embodiments 25 to 33 wherein the first polymeric region and the second polymeric region comprise different polymer compositions.

Embodiment 35 is the polymer composite of any one of embodiments 25 to 34 wherein the first polymeric region and the second polymeric region comprise different amounts of the same polymer composition.

Embodiment 36 is the polymer composite of any one of embodiments 25 to 35 wherein the first polymeric region has a first modulus or a first Tg; the second polymeric region has a second modulus or a second Tg; and the second modulus is different than the first modulus and/or the second Tg is different than the first Tg.

Embodiment 37 is the polymer composite of embodiment 36 wherein the ratio of the first modulus to the second modulus is greater than 1.2.

Embodiment 38 is the polymer composite of any one of embodiments 25 to 37 wherein the reinforcing phase comprises an organic material, an inorganic material, or a combination thereof.

Embodiment 39 is the polymer composite of embodiment 38 wherein the reinforcing phase comprises carbon (e.g., carbon nanotubes), polyaramide, polyolefin, glass, and metal.

Embodiment 40 is the polymer composite of any one of embodiments 25 to 39 wherein the reinforcing phase is in the form of fibers.

Embodiment 41 is the polymer composite of embodiment 40 wherein the fibers are electrically conductive fibers.

Embodiment 42 is the polymer composite of any one of embodiments 25 to 41 wherein the reinforcing phase is continuous.

Embodiment 43 is the polymer composite of any one of embodiments 25 to 41 wherein the reinforcing phase is discontinuous.

Embodiment 44 is the polymer composite of any one of embodiments 25 to 43 wherein the continuous matrix phase comprises a thermally cured resin.

Embodiment 45 is the polymer composite of embodiment 44 wherein the thermally cured resin comprises an epoxy resin, a polyester resin, a vinyl ester resin, a cyanate ester resin, or combinations thereof.

Embodiment 46 is the polymer composite of any one of embodiments 25 to 43 wherein the continuous matrix phase comprises a radiation cured resin.

Embodiment 47 is the polymer composite of embodiment 46 wherein the radiation cured resin comprises a cured acrylate and/or methacrylate resin.

Embodiment 48 is the polymer composite of embodiment 46 or 47 wherein the radiation cured resin comprises radiation sensitive curatives or radical generators.

Embodiment 49 is the polymer composite of any one of embodiments 25 to 43 wherein the continuous matrix phase comprises a dual cure resin.

Embodiment 50 is the polymer composite of any one of embodiments 25 to 49 which is in the form of a film.

Embodiment 51 is the polymer composite of any one of embodiments 25 to 49 which is in the form of a fiber.

Embodiment 52 is the polymer composite of embodiment 51 wherein the fiber is a continuous fiber.

Embodiment 53 is the polymer composite of embodiment 52 wherein the continuous fiber has differing properties along the length of the fiber.

Embodiment 54 is the polymer composite of any one of embodiments 51 to 53 wherein the fibers are in the form of a woven or knitted fabric.

Embodiment 55 is the polymer composite of any one of embodiments 25 to 49 which is in the form of a rod.

Embodiment 56 is a method for producing a fully cured polymer composite, the method comprising: providing a polymer resin and a reinforcing material dispersed therein; curing the polymer resin in a first polymeric region at a first rate, and curing the polymer resin in a second polymeric region at a second rate, to form the fully cured polymer composite; wherein the first and second cure rates are different; and wherein the first polymeric region is contiguous with the second polymeric region in the fully cured polymer composite.

Embodiment 57 is the method of embodiment 56 wherein curing comprises thermally curing.

Embodiment 58 is the method of embodiment 57 wherein the polymer resin comprises an epoxy resin, a polyester resin, a vinyl ester resin, a cyanate ester resin, or combinations thereof.

Embodiment 59 is the method of embodiment 58 wherein the polymer resin comprises an epoxy resin.

Embodiment 60 is the method of any one of embodiments 56 to 59 wherein the reinforcing material comprises fibers.

Embodiment 61 is the method of embodiment 60 where the reinforcing material comprises continuous fibers.

Embodiment 62 is the method of embodiment 61 wherein the reinforcing material comprises continuous electrically conductive fibers.

Embodiment 63 is the method of embodiment 62 wherein curing comprises heating the polymer resin through electrical resistance of the conductive fibers.

Embodiment 64 is the method of any one of embodiments 56 to 63 wherein curing occurs in less than 10 minutes (or less than 1 minute, or less than 15 seconds).

Embodiment 65 is the method of any one of embodiments 56 to 64 wherein the curing occurs continuously.

Embodiment 66 is a fully cured polymer composite made according to the method of any one of embodiments 56 to 65.

Embodiment 67 is the fully cured polymer composite of embodiment 66 comprising: a continuous matrix phase comprising contiguous first and second polymeric regions, wherein: the first polymeric region has a first modulus or a first Tg; the second polymeric region has a second modulus or a second Tg; and the second modulus is different than the first modulus and/or the second Tg is different than the first Tg; and a reinforcing phase.

Embodiment 68 is the fully cured polymer composite of embodiment 66 or 67 comprising: a continuous matrix phase comprising contiguous first and second polymeric regions, wherein the contiguous first and second polymeric regions have different material properties (e.g., modulus, Tg); and a reinforcing phase; wherein the polymer composite comprises contiguous first and second composite regions, each having different physical properties (e.g., polymer content, bending strength, stiffness).

### EXAMPLES

Objects and advantages of various embodiments of this invention are further illustrated by the following examples, but the particular materials and amounts thereof recited in these examples, as well as other conditions and details, should not be construed to unduly limit this invention. These examples are merely for illustrative purposes only and are not meant to be limiting on the scope of the appended claims.

### Examples

### Example 1

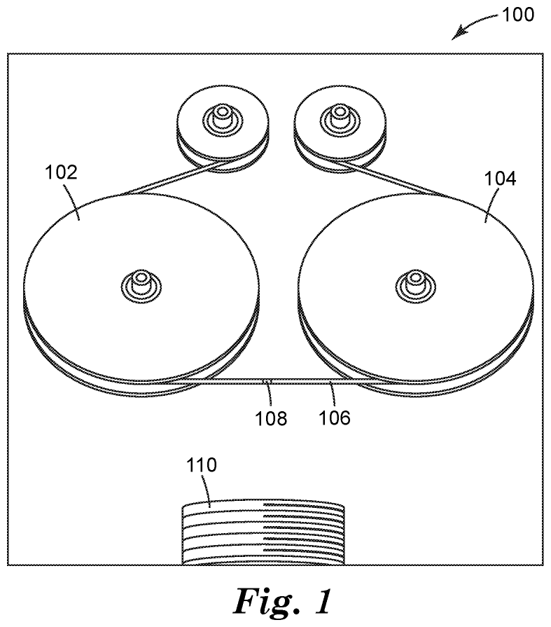

A 12,500-fiber count carbon fiber tow (TCR-T700SC-12K-50C, available from TCR Composites, Ogden, Utah) that was impregnated with 29.4% by weight of epoxy resin (TCR UF3369-100, available from TCR Composites, Ogden, Utah) was drawn taught between two 3-inch diameter rollers, with the span of composite between the rollers being 97 millimeters (mm). The rollers were connected to a programmable power supply having a 0.5-second response time to 90% of the specified current. The temperature of the resin-impregnated tow was measured with an IR pyrometer (model CTLF, available from Micro Epsilon GmbH & Co., Ortenberg, Germany) having a response time of 9 milliseconds (ms). The power supply applied 1.0 ampere (amp) for 300 seconds (secs) to the resin-impregnated tow to cure the resin. A representation of the apparatus is shown in FIG. 1.

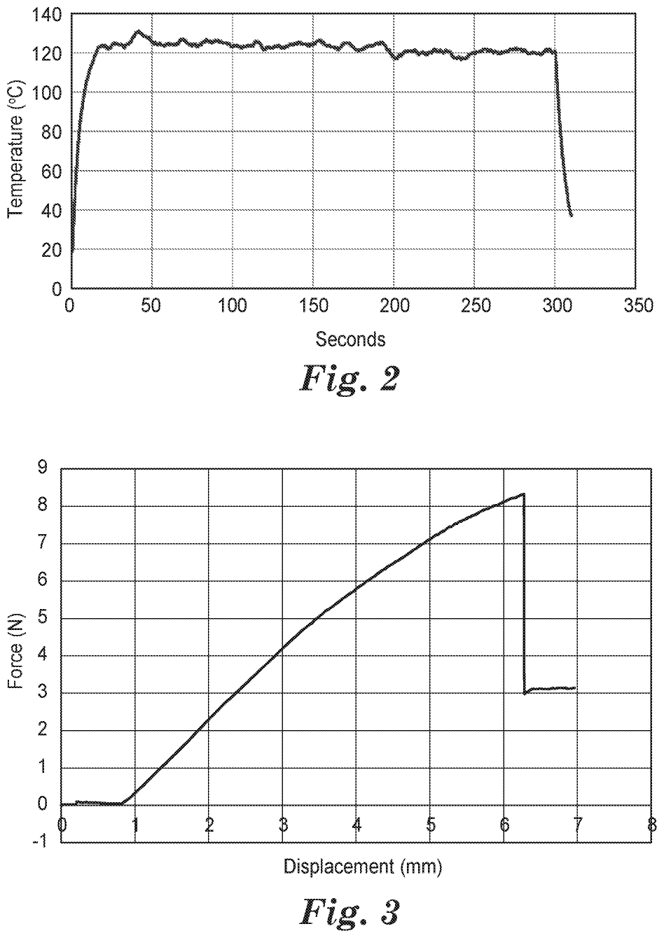

The fiber curing apparatus 100 had a pulley 102 connected to the positive potential, and pulley 104 connected to a negative potential of a power supply, with a conductive and thermosetting resin-impregnated tow electrically connecting pulley 102 and pulley 104. An IR pyrometer 110 monitored the temperature of the resin-impregnated tow between the two pulleys, with the measured region being 108. The temperature of the resin-impregnated tow during curing to form a polymer composite fiber is shown in FIG. 2.

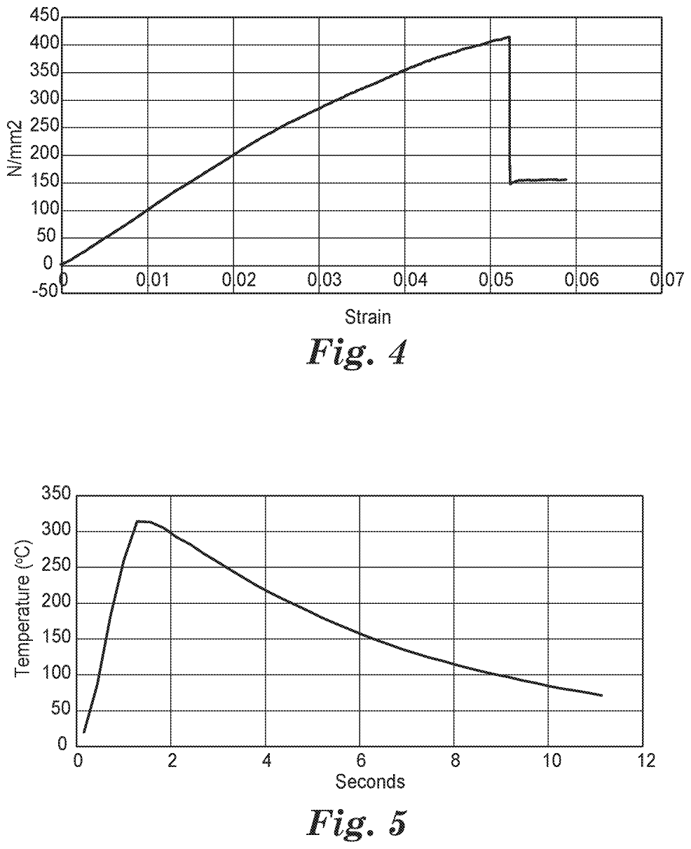

The resulting polymer composite fiber was cooled to room temperature, and then tested for 3-point flexural test. The span of the flexural tester was 25.0 mm, and the rate was 0.10 mm/sec. The cured polymer composite fiber was 0.47 mm thick and 3.41 mm wide. The curing resulted in a 0.24% loss of resin weight. The force vs. displacement curve of the cured fiber is shown in FIG. 3. The data of FIG. 3 was converted to stress and strain, and the results are shown in FIG. 4.

### Example 2

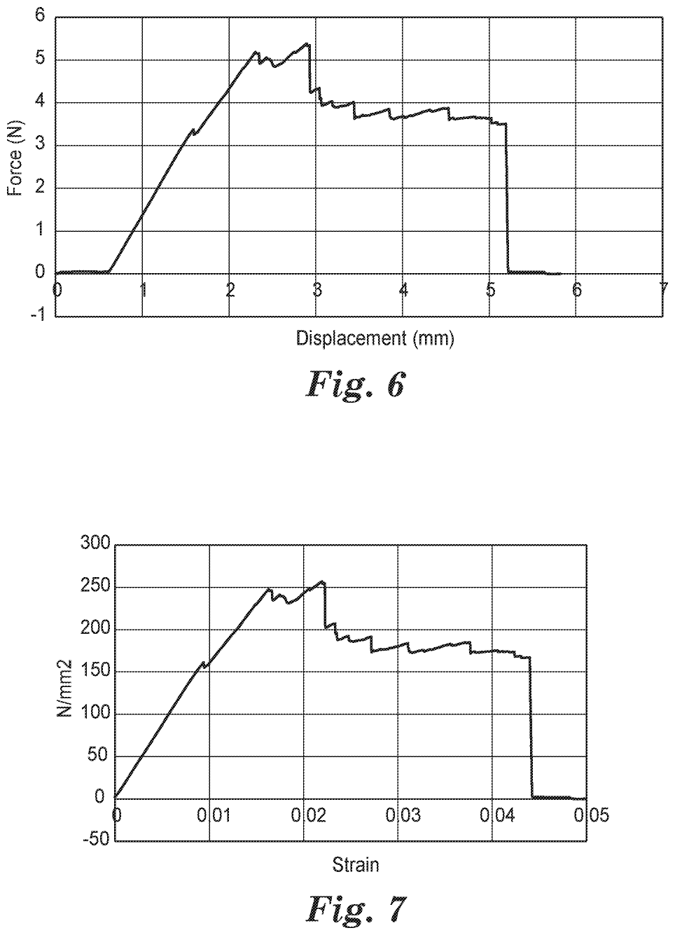

The process of Example 1 was repeated, except the power supply delivered 5.0 amps for 1.00 sec to cure the epoxy resin. The temperature of the resin-impregnated tow during curing to form a polymer composite fiber is shown in FIG. 5. The force vs. displacement curve of the cured fiber is shown in FIG. 6, and the calculated stress-strain curve is shown in FIG. 7. The curing resulted in a 20.6% loss of resin mass.

### Example 3

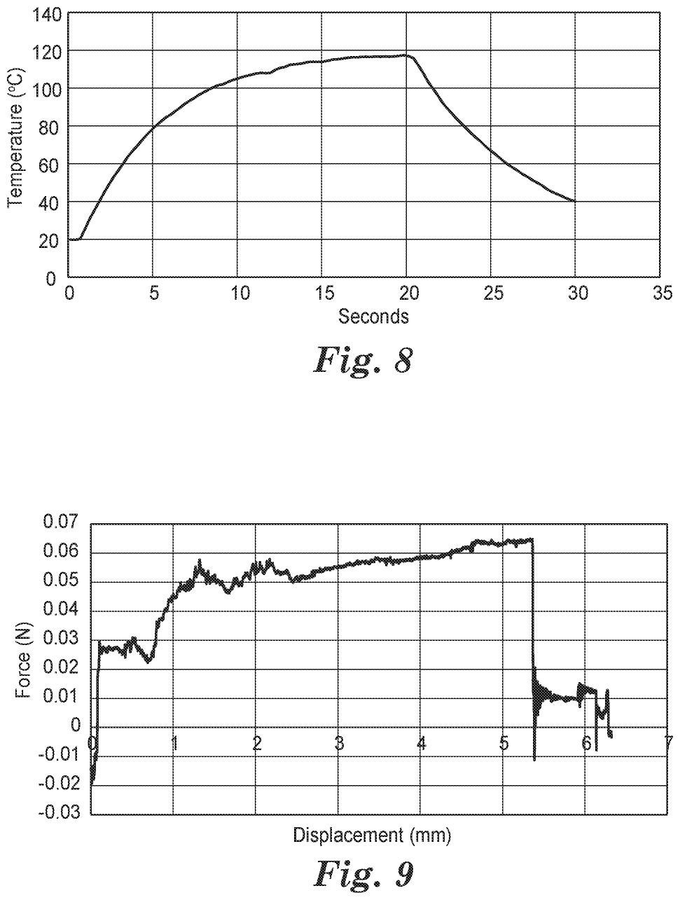

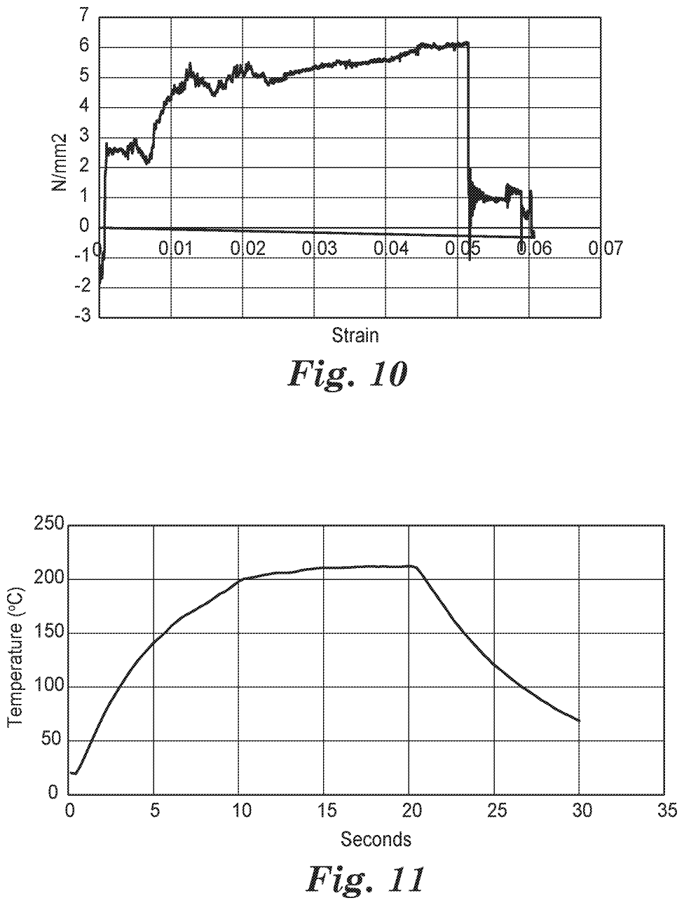

The process of Example 1 was repeated, except a current of 1.0 amp was applied for 20.0 secs to cure the epoxy resin. The temperature of the resin-impregnated tow during curing to form a polymer composite fiber is shown in FIG. 8. The force vs displacement curve of the polymer composite fiber is shown in FIG. 9, and the calculated stress-strain curve is shown in FIG. 10. Consistent with the stress-strain data, the polymer composite fiber had a low strength and stiffness, and unlike the much more fully cured fibers in Examples 1, 2, and 4, the polymer composite fiber created in Example 3 was only slightly stiffer than an uncured polymer composite. The curing resulted in a 0.0% loss of resin mass.

### Example 4

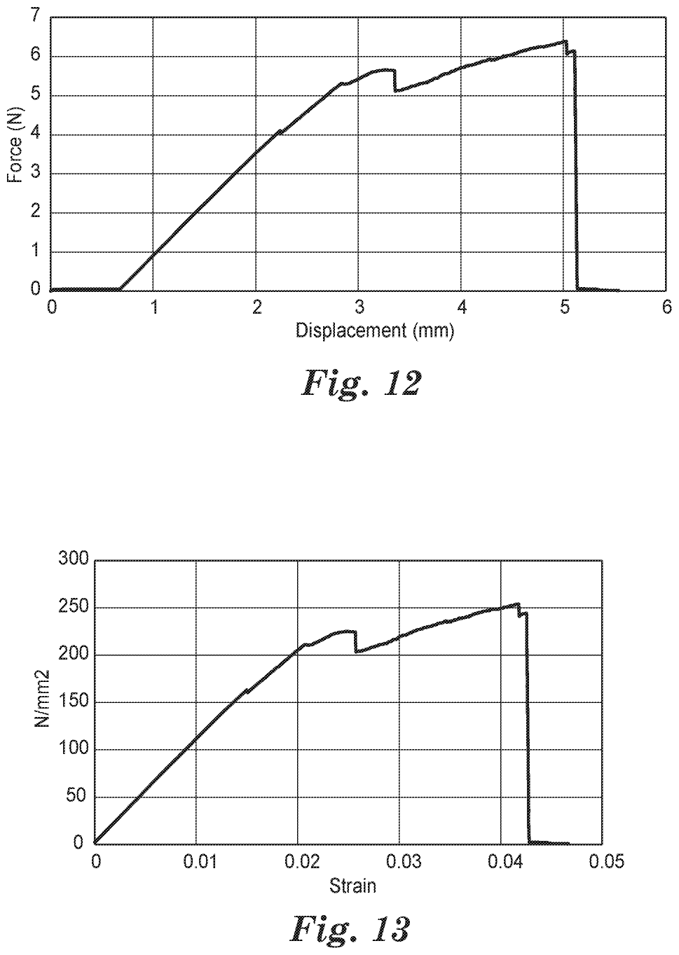

The process of Example 1 was repeated, except the power supply delivered 1.50 amps for 20.0 secs to cure the epoxy resin. The temperature of the resin-impregnated tow during curing to form a polymer composite fiber is shown in FIG. 11. The force vs. displacement of the polymer composite fiber is shown in FIG. 12, and the calculated stress-strain curve is shown in FIG. 13. The curing resulted in a 7.3% loss of resin mass.

### Example 5

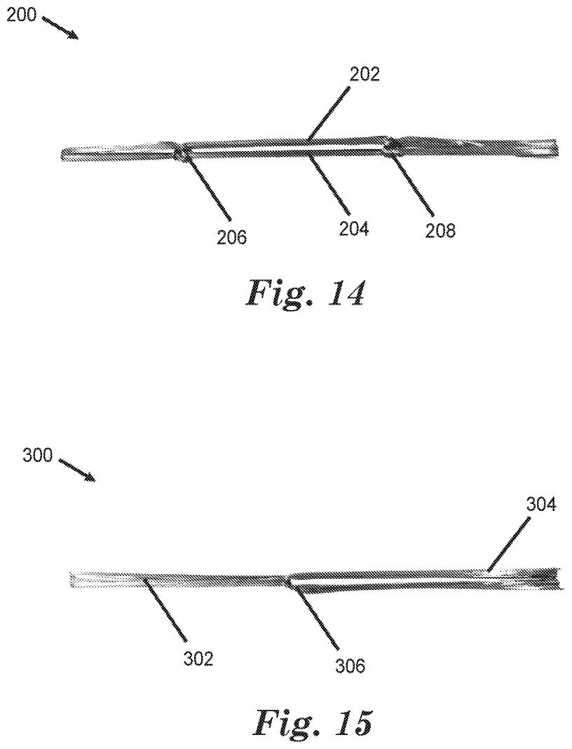

The epoxy resin-impregnated tow material of Example 1 was knitted into a structure as shown in FIG. 14. The combined resin-impregnated tow 200 had a looped tow 202 with loops 206 and 208, and a straight tow 204. A power supply delivered 3.0 amps to the resin-impregnated tows for 20.0 secs to cure the epoxy resin. The loops of the looped tow 202 were bonded to the straight tow 204, and both tows 202 and 204 exhibited a high degree of cure in the resultant polymer composite.

### Example 6

The epoxy resin-impregnated tow material described in Example 1 was looped as two tows as shown in FIG. 15. The looped tows 300 were made from a tow 302 and a tow 304, forming a loop 306. A power supply delivered 3.00 amps to the resin-impregnated tows for 20.0 secs to cure the epoxy resin. The resultant polymer composite exhibited a high degree of cure, but the junction between the two tows at the loop 306 was easily broken, allowing the looped tows to swivel.

### Example 7

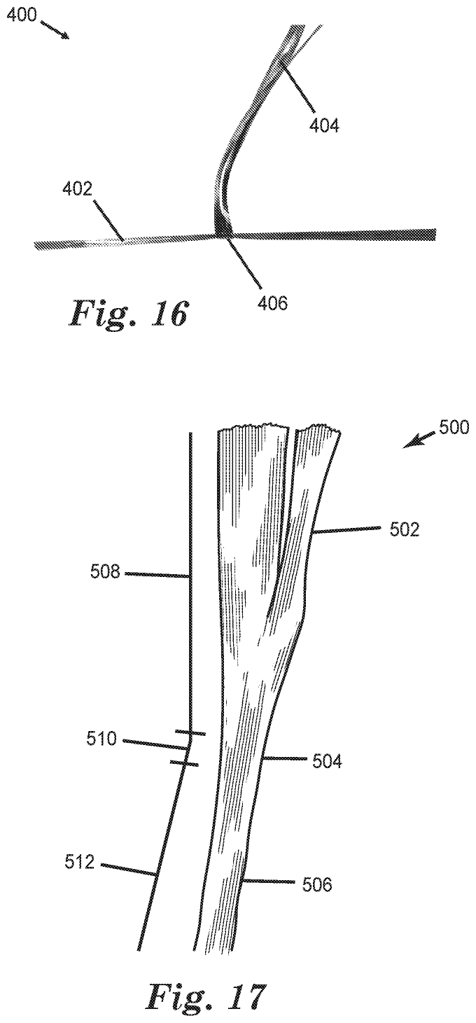

The epoxy resin-impregnated tow material in Example 1 was looped as shown in FIG. 16. The two tows 400 were made from a straight tow 402 and a tow 404 that was looped over tow 402. A power supply delivered 1.5 amps to a first straight tow 402, whereas a second looped tow 404 was electrically insulated such that there was little current flow through the second tow 404. The first tow 402 of the resultant polymer composite exhibited a high degree of cure, whereas the second tow 404 was uncured except where in contact with the first tow in the contact area 406. The two tows 402 and 404 were well bonded to each other.

### Example 8

The process of Example 1 was repeated, except the power supply delivered 1.1 amps for 300 secs to cure the epoxy resin. The average temperature of the epoxy resin-impregnated tow during this period was 124° C. resulting in a partially cured polymer composite. The partially cured polymer composite was cooled to room temperature, and then the power supply delivered 10 amps for 5 secs to further cure the epoxy resin. The peak temperature was 430° C. with smoke being emitted during heating. The resultant cured polymer composite was cooled to room temperature. The reinforcing fibers in the resultant polymer composite did not appear damaged. The polymer composite 500 was cut between the two pulleys. There were three distinctly different regions. The first region, 502 with length 508, where there was no substantial current flow and there was good contact with the pulley, was uncured. The second region 504 with length 510, where the resin-impregnated tow was heated by the current, but was in close proximity to the pulley, the epoxy was well cured and the resultant composite had substantial stiffness and strength. The second region 504 was about 4 mm long. In the third region 506, with length 512, in the space between the pulleys, the reinforcing fibers in the resultant polymer composite were easily and cleanly separated. FIG. 17 is a representation of the three regions of the composite.

### Results

Examples 1, 2, 3, 4, and 8 are summarized in Table 1. These results show that the stiffness and maximum strength of the polymer composite can vary over a wide range depending on the curing conditions. For example, a polymer composite article may be prepared with some regions having high strength and less stiffness, other regions with high stiffness and less strength, other regions that can be cured at a later time, and some that are extremely flexible with high tensile strength and very low compressive strength. Other combinations of strength and stiffness can be created by altering curing conditions, including current, time, using more complex combinations of current and time, and post processing such as curing a completed assembly at the manufacturer's recommended cure time and temperature. It may be desirable also to change the resin loading of the composite from normal loadings. For example, higher resin loadings of 35%, 45%, or 60% by weight may be incorporated in the uncured tow.

TABLE 1

| Example | Current | Time | Stiffness+ | Maximum Strength |
|---|---|---|---|---|
| 1 | 1 | 300 | 100 | 415 |
| 2 | 5 | 1 | 170 | 260 |
| 3 | 1 | 20 | 4.4 | 6 |
| 4 | 1.5 | 20 | 115 | 255 |
| 8 | 10 | 5 | * | * |

* Unbound fibers - high tensile strength, low compressiv [symbol]
+Stiffness measured as N/mm2 at 1% engineering strain [symbol]
indicates data missing or illegible when filed

### Alternative Processing Equipment

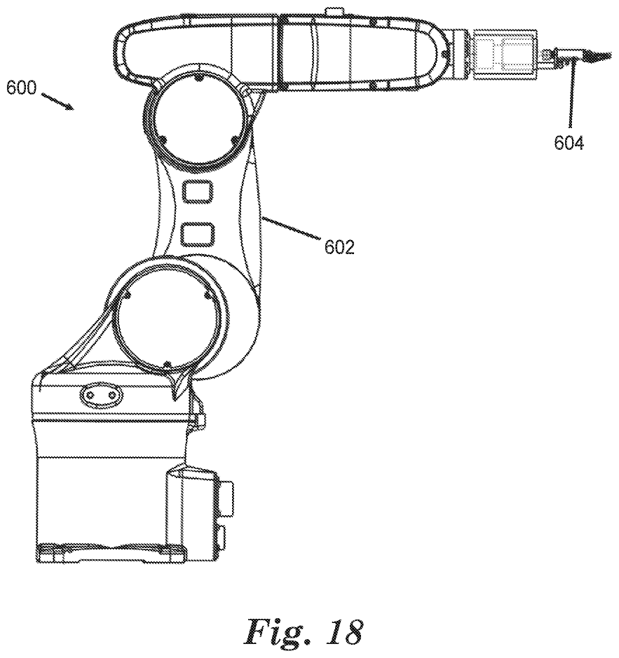

FIG. 18 shows alternative equipment for preparing polymer composite fibers with a rapidly cured resin, wherein a three-dimensional (3D)-articulated system 600, having a multi-axis mechanical control system 602, manipulates a fiber dispensing system 604.

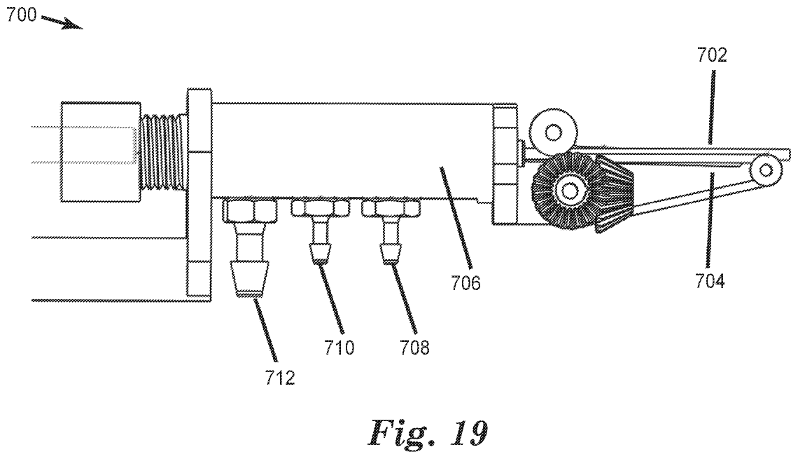

FIG. 19 shows a perspective of a fiber delivery head 700. A fiber tow (not shown) enters a resin impregnation head 706. The head 706 has vacuum ports 708 and 712, and a resin delivery port 710. Resin-impregnated tow 702 is pulled from the impregnation head 706 by a computer-controlled belt 704.

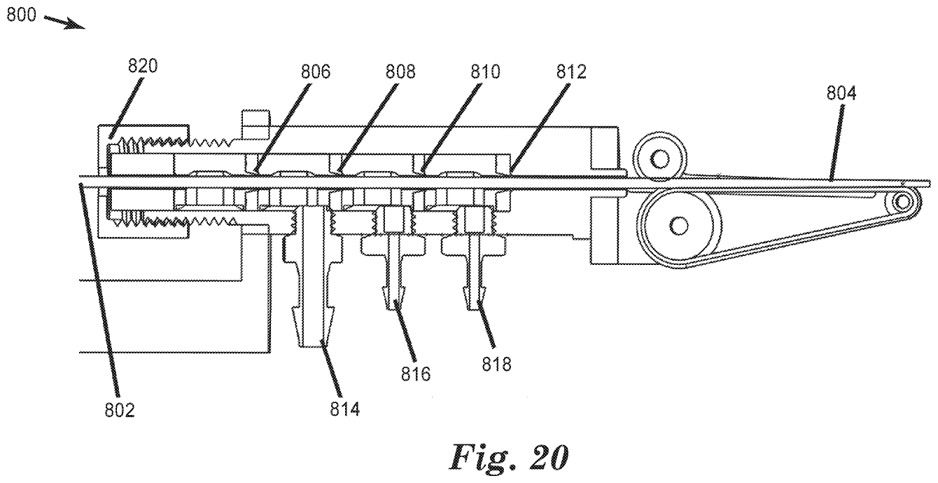

FIG. 20 shows a cross-sectional view of a resin impregnation head 800, wherein a fiber tow 802 passes through a constriction 806, followed by a cavity evacuated by vacuum applied to port 814. The evacuated fiber tow then passes through constriction 808 to a cavity that is filled with a thermosetting resin through port 816. The impregnated fiber then passes through a constriction 810 into an optional vacuum cavity evacuated by port 818.

The complete disclosures of the patents, patent documents, and publications cited herein are incorporated by reference in their entirety as if each were individually incorporated. Various modifications and alterations to this disclosure will become apparent to those skilled in the art without departing from the scope and spirit of this disclosure. It should be understood that this disclosure is not intended to be unduly limited by the illustrative embodiments and examples set forth herein and that such examples and embodiments are presented by way of example only with the scope of the disclosure intended to be limited only by the claims set forth herein as follows.

1. A polymer composite in the form of a fiber or rod, the composite comprising:
a fully cured continuous matrix phase comprising contiguous first and second polymeric regions, wherein:
the first polymeric region has a first modulus or a first Tg;
the second polymeric region has a second modulus or a second Tg; and
the second modulus is different than the first modulus and/or the second Tg is different than the first Tg; and
a reinforcing phase comprising continuous fibers.

2. The polymer composite of claim 1 wherein the first polymeric region and the second polymeric region comprise the same polymer composition, and wherein the continuous matrix phase comprises a thermally cured epoxy resin.

3. A polymer composite in the form of a fiber or rod, the composite comprising:
a fully cured continuous matrix phase comprising contiguous first and second polymeric regions, wherein the contiguous first and second polymeric regions have different material properties; and
a reinforcing phase comprising continuous fibers;
wherein the polymer composite comprises contiguous first and second composite regions, each having different physical properties.

4. The polymer composite of claim 3, wherein the first and second composite regions each have a bending strength, wherein the bending strength of the first composite region is different than the bending strength of the second composite region.

5. The polymer composite of claim 3, wherein the first and second composite regions each have a stiffness, wherein the stiffness of the first composite region is different than the stiffness of the second composite region.

6. The polymer composite of claim 3, wherein the first polymeric region and the second polymeric region comprise the same polymer composition cured differently.

7. The polymer composite of claim 3, wherein the first polymeric region has a first modulus or a first Tg; the second polymeric region has a second modulus or a second Tg; and the second modulus is different than the first modulus and/or the second Tg is different than the first Tg.

8. A method for producing a fully cured polymer composite, the method comprising:
providing a polymer resin and a reinforcing material dispersed therein;
curing the polymer resin in a first polymeric region at a first rate, and curing the polymer resin in a second polymeric region at a second rate, to form the fully cured polymer composite;
wherein the first and second cure rates are different; and
wherein the first polymeric region is contiguous with the second polymeric region in the fully cured polymer composite.

9. The method of claim 8 wherein curing comprises thermally curing.

10. A fully cured polymer composite made according to the method of claim 8.

11. The polymer composite of claim 1, wherein the first polymeric region and the second polymeric region comprise different polymer compositions.

12. The polymer composite of claim 1, wherein the first polymeric region and the second polymeric region comprise a same polymer composition cured differently.
